(19) United States
(12) Patent Application Publication
(10) Pub. No.: US 2020/0344549 A1
(43) Pub. Date: Oct. 29, 2020

(54) SYNCHRONIZED MULTIUSER AUDIO

(71) Applicant: Left Right Studios Inc., Santa Monica, CA (US)

(72) Inventor: Jonathan B. Wegener, Santa Monica, CA (US)

(21) Appl. No.: 16/392,152

(22) Filed: Apr. 23, 2019

(51) Int. Cl. H04R 3/12; H04R 5/033; H04R 5/04; H04S 1/00; H04R 1/10; G09G 5/10; H04N 5/04; G06F 3/16

(52) U.S. Cl. CPC H04R 3/12; H04R 5/033; H04R 5/04; H04S 1/007; H04R 2420/07; G09G 5/10; H04N 5/04; G06F 3/165; H04S 2400/13; H04R 1/1016

(57) ABSTRACT

An audio recording is received that includes a first audio content for a first user in a left audio channel and a second audio content for a second user in a right audio channel. The first audio content is synchronized with the second audio content within the audio recording. At least a portion of the audio recording is provided for playback on a headphone, wherein a left ear speaker of the headphone provides the first audio content isolated for the first user and a right ear speaker of the headphone provides the second audio content isolated for the second user.

### BACKGROUND OF THE INVENTION

Smartphone and other personal media playing devices provide users with very personalized audio consumption experiences including the ability to play music, consume podcasts, listen to audiobooks, and participate in guided meditation. With headphones, the media consumption experience on these devices is even more intimate and immersive. However, there exists a need to expand the media playing experience beyond that of an individual one with the ability to play synchronized multiuser audio—a technique important to a new breed of storytellers designing experiences for multiple people. In some scenarios, the participants are in close proximity to one another and can physically interact with one another. A particularly challenging technical problem is providing different audio content to different users while keeping that audio synchronized. The synchronization process between devices is typically tedious and prone to errors.

### BRIEF DESCRIPTION OF THE DRAWINGS

Various embodiments of the invention are disclosed in the following detailed description and the accompanying drawings.

FIG. 1 is a flow chart illustrating an embodiment of a process for providing synchronized multiuser audio.

FIG. 2 is a flow chart illustrating an embodiment of a process for creating synchronized multiuser audio content.

FIG. 3 is a flow chart illustrating an embodiment of a process for providing synchronized multiuser audio.

FIG. 4 is a flow chart illustrating an embodiment of a process for providing synchronized multiuser audio.

FIG. 5 is a flow chart illustrating an embodiment of a process for providing synchronized multiuser audio.

FIG. 6 is a flow chart illustrating an embodiment of a process for creating a highlight recording of a synchronized multiuser audio-based session.

FIG. 7 is a functional diagram illustrating a programmed computer system for providing synchronized multiuser audio.

FIG. 8 is a block diagram illustrating an embodiment of a content platform system for providing synchronized multiuser audio.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A synchronized audio-based experience for multiple users using a single stereo audio recording is disclosed. The stereo audio recording has separate left and right audio channels that are directed to two different users. Each user wears an audio device such as a left half or a right half of an audio device pair. For example, a first user wears the left channel portion (e.g., the left ear speaker) and a second user wears the right channel portion (e.g., the right ear speaker) of a pair of headphones. In some embodiments, the pair of headphones is a wireless audio device or a pair of wireless earbuds. In some embodiments, the headphones are wireless headphones where the left and right ear speakers are not physically connected. For example, the wireless audio device can be a set of Apple AirPods and the first user wears the left AirPod and the second user wears the right AirPod. Once both users are wearing their respective portions of an audio device, a synchronized audio experience is played through their corresponding audio devices using the different audio channels. The left and right channels are customized for each user's experience and each channel plays different but synchronized content. For example, in some embodiments, a first user receives an experience and a second user gives or enhances the experience for the first user. While the first user receives an immersive audio experience, often with the user's eyes closed, the second user receives audio instructions to provide sensory actions directed at the first user. For example, as a first user hears the sound of wind, the second user, following instructions included in the second user's audio content, blows air at the first user. By synchronizing the second user's audio instructions with the first user's audio, the actions performed by the second user enhance the first user's experience. Examples of audio instructions include directing the second user to brush, tickle, tap, blow, whisper, caress, laugh, shout, roar, etc. to enhance the first user's experience. In turn, the first user receives an immersive and engaging experience by listening to the audio experience and receiving the directed sensory actions. By synchronizing the two audio channels, the external sensory actions provided to the first user deepen and enhance the received audio experience. In some embodiments, additional external sensory interactions may also be provided by additional hardware such as a smartphone device, wearable device, and/or smart home device, etc. The additional hardware can be synchronized with the audio to provide vibration, lighting, change in colored lighting, dynamic/adaptive content generation, etc. to enhance the experience for users. For example, a smartphone's camera flash (or display) can be configured to briefly flicker at the precise moment a crack of thunder is played, creating the visual sensation of lightning to accompany the audio content.

In some embodiments, an audio recording that includes a first audio content for a first user in a left audio channel of the audio recording and a second audio content for a second user in a right audio channel of the audio recording is received. For example, a stereo audio recording includes the first audio content in one channel for the first user and the second audio content in another channel for the second user. The first and second audio content may be played on left and right audio channels (or vice versa) and each channel is directed uniquely at the first or second user. In some embodiments, the first audio content is synchronized with the second audio content within the audio recording. For example, the content of the first and second audio content are created to be played together but the content of the first and second audio content are different. The first user and the second user are intentionally provided with different audio content when playing the synchronized content of the audio recording. For example, the first user may be immersed in an audio narrative while the second user hears audio instructions directing the second user to perform sensory actions on the first user. In some embodiments, both users may additionally hear a shared background audio duplicated across both the first and second audio content. In some embodiments, at least a portion of the audio recording for playback on a headphone is provided, wherein a left ear speaker of the headphone provides the first audio content isolated for the first user and a right ear speaker of the headphone provides the second audio content isolated for the second user. For example, the audio content for the first user is played to only the first user using the left ear speaker and the audio content for the second user is played to only the second user using the right ear speaker. The first and second audio content of the audio recording are at least in part synchronized by playing the audio recording via the headphone shared by the two users. The audio heard by each user is isolated since each user only has the left or right ear speaker of the headphone. Since each of the first and second users wears a corresponding portion of the headphone, i.e., the left or right ear speakers, the two users receive their respective audio content in sync.

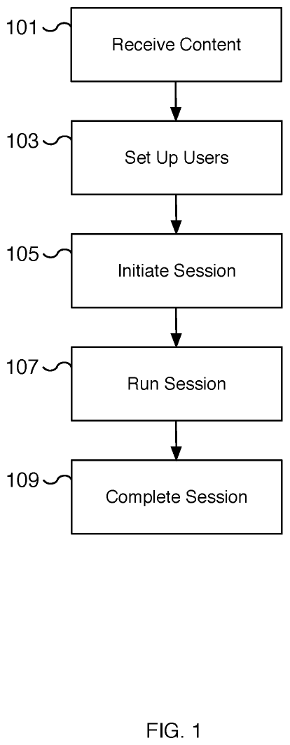

FIG. 1 is a flow chart illustrating an embodiment of a process for providing synchronized multiuser audio. In some embodiments, an immersive and engaging experience is created for shared users of the synchronized audio. The synchronized audio may be the basis of a narrative experience similar to group storytelling. In some embodiments, a personal media player such as a smartphone device is used to play the synchronized multiuser audio with separate audio directed to each user. The audio is synchronized so all users share in the same audio-based experience but can be customized so each user can participate in the experience differently.

At 101, content is received. The content received includes at least a synchronized multiuser audio recording with at least two channels. For example, a left channel and a right channel of a stereo audio recording provide different content for two different users but are synchronized so that when played together the two users share in the same audio-based experience. In some embodiments, additional descriptor information is used to synchronize additional effects such as lighting, vibration, and flash effects, among others, with the audio recording. The additional descriptor information may be implemented using a descriptor file, metadata information, a record (such as a database record), and/or via another appropriate technique.

At 103, users are set up. For example, multiple users are configured and set up to prepare each user for experiencing and participating in a session based on the synchronized multiuser audio recording. In some embodiments, there are two users and each user wears one portion of a pair of headphones. In some embodiments, the headphones are earbuds. In some embodiments, the headphones are wireless headphones where the left and right ear speakers are not physically connected. In some embodiments, the headphones are Apple AirPods and each user wears one AirPod.

In various embodiments, the setup process includes configuring settings for each user. The users are presented with a user interface for configuring settings. For example, the users may independently control the volume of the content each user hears by adjusting their respective volume settings. In some embodiments, users can set configuration settings including language settings to control the language of the content played. For example, a user can configure the language to select between different languages such as English, Spanish, French, Mandarin, etc. and the corresponding user's audio content of the multiuser audio recording is changed to the configured language setting. Other configuration settings may include selecting a speaker of the audio content, for example, selecting from adult, child, male, female, regional accent, or other appropriate configuration settings. In some embodiments, the configuration settings include the ability to set the speed of the audio such as the speed of the speaker's speech, modifications to enable or disable ambient or background sounds and/or their volume, modifications to environmental sounds, etc. In some embodiments, a user can configure which portion of the headphones each user wears. For example, two users can swap which user wears the left and which user wears the right ear speaker. In some embodiments, the users determine which portion of a pair of headphones each user wears and which of the two users is the receiver of the audio-based experience and which will receive audio instructions to enhance the experience for the other.

At 105, a session is initiated. Once the users are set up and their audio devices are ready, the session is initiated. In some embodiments, the session includes confirming the audio devices and users are properly configured and that the audio is synchronized. In some embodiments, the users receive audio and/or visual (e.g., text on a display) directions as part of initializing the session. For example, the users are asked to arrange their physical positions relative to one another. Instructions may direct the first user to be positioned to the left of the second user. As another example, the first user may be directed to lie down and the second user may be directed to sit next to the first user. In various embodiments, initialization instructions are presented to the users.

At 107, the session is run. Once the users are set up and the session is initialized, the session is run. In some embodiments, the session includes playing the synchronized multiuser audio recording to each of the multiple users. For example, a first user receives audio content and the second user receives audio content different from the first user. In various embodiments, the synchronized multiuser audio recording includes both the first user's and second user's audio content.

In some scenarios, one user receives audio content such as a story narrative and a second user receives audio instructions for the second user to follow. The instructions may direct the second user to perform sensory actions on the first user such as whispering, caressing, holding the first user's hand, tickling, laughing, or other appropriate actions. The instructions add to the experience and are timed such that the second user performs them at the appropriate time. In some embodiments, the audio instructions include a start signal and an optional stop signal for starting and stopping the action to be performed. In some embodiments, the start and stop signals are audio cues in the audio content, such as a silencing of or a change in volume for the background audio content.

In some embodiments, additional sensory effects are performed while the session runs. For example, the display of the smartphone device can be controlled to display different brightness settings and colors. When held up to a user's face with the user's eyes closed, the smartphone device display can be used to perform lighting effects such as simulating environmental lighting (e.g., a sunset, a spotlight, a strobe light, lightning, etc.). In some embodiments, other hardware such as a camera flash, a haptic engine, a gyroscope, a vibration module, a camera sensor, or another appropriate hardware module is used to enhance the audio experience. For example, an actuator can be controlled to vibrate the smartphone device. When synchronized with the audio content, the vibration effect can create the perception of footsteps, knocking, or other events. In various embodiments, other hardware devices can be used to enhance the experience including monitoring the users, such as monitoring the user's heart rate. In various embodiments, the additional sensory effects synchronized with the audio recording may be implemented using a descriptor file, metadata information, a record (such as a database record), and/or via another appropriate technique.

At 109, the session is completed. In various embodiments, the session is complete when the synchronized multiuser audio recording has finished playing or the session is paused. For example, a user may remove one of the ear speakers to cause the session to pause, completing the session. In various embodiments, a new session can be started to resume the completed session. In some embodiments, playback data is saved at the time of completion. For example, playback data may include a measure of the length of time played, the timestamp of the audio recording when stopped, the heart rate and/or running heart rate of users during the session, which user is responsible for pausing or terminating the session, and other appropriate measurements or analytics data. In some embodiments, the session completes by presenting instructions to one or more users for receiving feedback on the session. The feedback may include whether and how much the user enjoyed the session, ratings for the session, descriptions of the session experience, why the session was paused in the event the session did not run its entire length, etc. In some embodiments, users can share and/or review captured moments from the session.

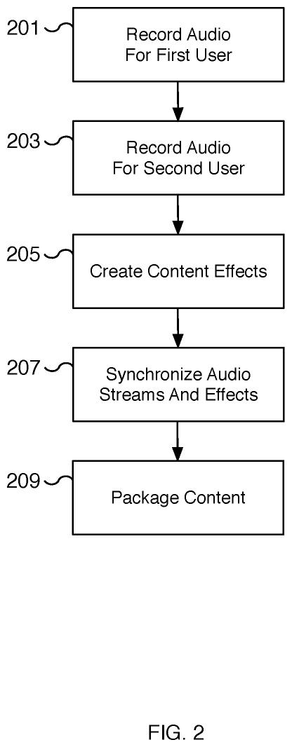

FIG. 2 is a flow chart illustrating an embodiment of a process for creating synchronized multiuser audio content. In some embodiments, the content created is used by the processes described herein, including the processes of FIGS. 1 and 3-6. In some embodiments, the process of FIG. 2 is used to create the content received at 101 of FIG. 1. The received content includes a synchronized multiuser audio recording and optional descriptor information to describe additional effects. The optional descriptor information may be implemented using a descriptor file, metadata information, a record (such as a database record), and/or via another appropriate technique.

At 201, audio is recorded for the first user. An audio recording directed at a first user is recorded. In some embodiments, the audio recording includes audio instructions for performing different actions. The audio instructions may include a start signal and an optional end signal to inform the user when to start and end the action. For example, a start signal may be a countdown or a bell to indicate starting an action such as whispering a sentence. As another example a start signal may indicate the time to start a physical gesture such as caressing the other user's arms or massaging the other user's shoulders. An end signal indicates when the action should finish. In various embodiments, the start and end signals are inserted to synchronize the actions performed by the first user with the audio stream of another user, such as the user the action is directed towards. In some embodiments, the audio recording may resemble a narrative along the lines of storytelling that the user listens to. For example, the audio recording may include a narrator describing an environment and actions while background and environmental sounds play to enhance the immersive experience. In some embodiments, multiple versions of the recording are made corresponding to different language settings.

At 203, audio is recorded for the second user. An audio recording directed at a second user is recorded. The audio recording of 203 is created to be played in a synchronized manner along with the audio recording of 201. In some embodiments, the audio recording includes audio instructions for performing different actions as described above with respect to 201. In some embodiments, multiple versions of the recording are made corresponding to different language settings. In some embodiments, the audio recordings of 201 and 203 share similar audio sources such as background and/or environmental sounds. In some scenarios, the audio recordings of 201 and 203 share portions of the exact same audio for portions of the experience.

At 205, content effects are created. In some embodiments, content effects such as hardware effects (including sensory-based effects) are implemented using a smartphone device, wearable smart device, smart home device, or another appropriate device. For example, descriptor information may be utilized to describe different effects and the times the effects should be performed. In various embodiments, the descriptor information may be described in a descriptor file, a descriptor record (such as a database record), metadata information, and/or via another appropriate technique. In some embodiments, the descriptor information is used to implement hardware effects such as controlling the display of a smartphone device. The color and brightness of the display can be modified, for example, to simulate a sunset or other lighting effects. The color can be specified using a color description such as a color code, name, or hex value. As another example, the descriptor information may be used to control the camera flash of a smartphone device. Effects using the camera flash include a strobe light, flickering flames, or spotlight, among others. The descriptor information may also be used to implement vibration or motion effects using hardware such as a motorized actuator, haptic engine, or vibration module of a smartphone device. Vibration effects can be used to simulate movement, footsteps, thunder, etc. When synchronized with an audio stream, the sensory impact of the effect is significantly enhanced. In some embodiments, the descriptor information can be used to implement camera effects such as capturing media such as photos, videos, and/or audio. The captured media can be used in the audio recording and/or to generate a highlight recording of the experience. For example, a user's voice can be recorded and played as part of the audio experience. In various embodiments, the descriptor information can be implemented as an additional effects file, record, metadata, and/or via another appropriate technique. In some embodiments, the descriptor information is implemented as a programming script and/or compiled program that can call one or more different Application Programming Interfaces (APIs) for controlling a hardware device.

In some embodiments, the content effects include audio and/or text descriptions such as instructions that are encoded into the audio recording and/or displayed on a screen while listening to the audio recording. The audio may be generated by converting the text using text to speech technology. In some embodiments, the text directions may be displayed on the screen twice, one version in an orientation to allow a first user to read the text and another version in an orientation to allow a second user to read the text. For example, two users may be facing one another with a display screen positioned between them so that both users can view the screen. The text can be mirrored so both users can easily read the text.

In some embodiments, one or more sensors of a smartphone device are used to create dynamic content effects. For example, a gyroscope can be monitored to reflect the positioning of different users. The audio can be modified dynamically to reflect changing positions. For example, the audio volume and direction can be modified. As another example, a heart rate sensor/monitor can be used to trigger dynamic content. For example, a soothing sound can be played until a user's heart rate slows. As another example, tense or dynamic music can be played until the user's heart rate reaches a particular level. In some embodiments, the user's heart rate can be monitored to dynamically modify the audio recording. For example, a background beat or sound effect can be synchronized to a user's heart rate. As another example, a strobe light or other hardware effect can be synchronized to a user's heart rate. In some embodiments, a user's breathing is monitored using a microphone and content is dynamically modified based on the analyzed breathing pattern.

In some embodiments, a third audio recording is played along with the first and second user's audio recordings. The third audio recording may be played on a second device such as a smart home speaker or smartphone device. The third audio recording can be used to implement background sound effects that all users hear. For example, a third audio stream can play background café or weather sounds.

In some embodiments, an additional hardware device can be used to perform content effects. For example, a wearable smart device such as a smart watch or heart rate monitor can be used to perform heart rate monitoring, position and orientation monitoring, vibration effects, audio cues, etc. As another example, smart home devices can perform content effects such as lighting, audio, temperature, and camera effects, among others. For example, a room's lights can dim, brighten, change color, etc. based on a created lighting effect. As another example, a room's temperature can be made cooler or warmer based on a created temperature effect. Similarly, audio effects can be played using a smart home audio speaker. A smart home camera can be used to capture audio, video, or photos for creating camera effects.

At 207, audio streams and effects are synchronized. Using the audio recordings of 201 and 203, a synchronized multiuser audio recording is created. In some embodiments, the recording is a stereo audio recording where the first user's recording is one channel and the second user's recording is a different channel of a stereo recording. For example, the left channel includes the first user's recording and the right channel includes the second user's recording. In various embodiments, the two audio streams are merged into a single audio recording using different channels. By merging the two audio streams into a unified synchronized multiuser audio recording, the timing of the audio streams is synchronized such that both can be played together.

In some embodiments, the content effects created at 205 are synchronized with the generated synchronized multiuser audio recording. The content effects may be implemented using descriptor information that describes each content effect to be performed and the timing of the effect relative to the generated synchronized multiuser audio. For example, a strobe effect may describe the strobe settings such as the brightness and rate of the strobe effect including the on/off timing between flashes as well as when the strobe effect should begin and when the strobe effect should end, and/or other appropriate parameters. As another example, a vibration effect includes when to start the vibration, how long to perform the vibration, a vibration strength setting, and/or other appropriate vibration effects parameters. In various embodiments, the content effects are synchronized with the audio streams to ensure that they are performed with the correct timing.

At 209, the content is packaged. The synchronized multiuser audio recording and optional content effects are packaged into a session. In some embodiments, the session includes additional descriptors and/or metadata such as a title, a content category, a target user demographic, a content rating, a price, content attributions, etc. For example, content categories may include content targeting children and parents, content targeting intimate partner scenarios, and content with suspense or thriller aspects. Additional or fewer categories may be appropriate. In some embodiments, a rating system is used to categorize the content of the session such as whether the content is appropriate for different ages and/or maturity levels. The content may also be classified using keywords to help users identify relevant content and/or to improve the ability to search for different content. In some embodiments, content attributions are used to attribute the content such as identifying writers, producers, voice talent, sound effects producers, etc. The content attributions can be used to help identify relevant content, for example, content that includes a user's favorite writers and/or voice talent.

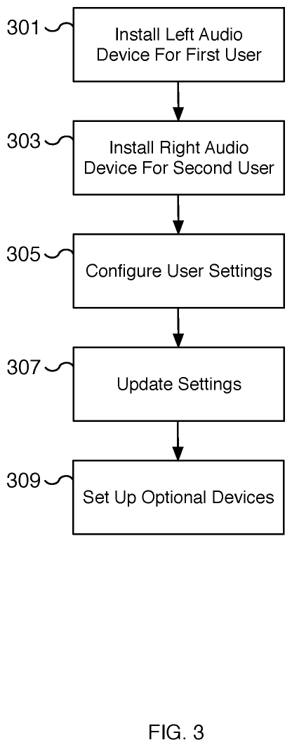

FIG. 3 is a flow chart illustrating an embodiment of a process for providing synchronized multiuser audio. In some embodiments, the process of FIG. 3 is used to configure users for receiving an audio-based experience using a synchronized multiuser audio recording. In some embodiments, the process of FIG. 3 is performed at 103 of FIG. 1. In some embodiments, users are configured for receiving the content generated using the process of FIG. 2.

At 301, the left audio device is installed for a first user. For example, a first user wears or puts on a left ear speaker of a pair of headphones. In some embodiments, the pair of headphones is a pair of wireless headphones. The audio device or headphones may be earbud style or another style of headphones. In some embodiments, the first user wears a left AirPod of a pair of Apple AirPods or another similar left audio device that is not physically connected to the right audio device and is wireless. Once worn, the left ear speaker can be connected to a personal media playing device such as a smartphone device. In some embodiments, the connection is a wireless connection such as a Bluetooth connection.

At 303, the right audio device is installed for a second user. In various embodiments, the right audio device is the corresponding right ear speaker of the left audio device installed at 301. The right audio device is installed for a second user that is different from the first user. As described with respect to the left audio device, the right audio device may be a wireless audio device wherein the right and left ear speakers are not physically connected.

At 305, user settings are configured. In various embodiments, the user settings include audio device configuration settings, volume settings, language settings, and/or voice speaker settings, among others. Audio device configuration settings may include connection settings such as Bluetooth settings. In some embodiments, volume settings include independent volume settings for each user. For example, the first and second user may independently configure volume settings. A volume configuration sound is played through each configured ear speaker and adjusted according to the volume setting for that user. The configuration sound can be used by the user to confirm the volume is correctly adjusted. In some embodiments, the users can further configure language and/or speaker settings such as selecting a language and/or voice speaker for the audio content. Additional configuration settings can be set such as swapping the right and left audio content so that the left audio recording plays in the right ear speaker and the right audio recording plays in the left right speaker.

At 307, the settings are updated. For example, the settings are updated for the current or soon to be played session. Settings such as volume, language, and/or voice speaker settings may be previewed by users. In some embodiments, the settings are updated and validated to confirm that they are correctly configured. The settings may be saved and used for future sessions. In some embodiments, the settings are stored as a user configuration and may be stored on a remote server to later access. In various embodiments, each user has a user configuration and the settings for each user of the group may be stored independently.

At 309, optional devices are set up. In some embodiments, optional devices such as a smart wearable device, smart home device, secondary speakers, etc. are set up. In some embodiments, these devices are set up and confirmed to be configured correctly. For example, the volume of a secondary speaker such as a smartphone device or smart home speaker is confirmed to be correctly adjusted by playing sample audio to the device and allowing users to adjust the volume. In some embodiments, a microphone is used to adjust the volume settings. For example, a microphone of the headphones or smartphone device may be used to configure the volume of an optional device. In various embodiments, network connections to the optional devices are confirmed to be working correctly during the setup step.

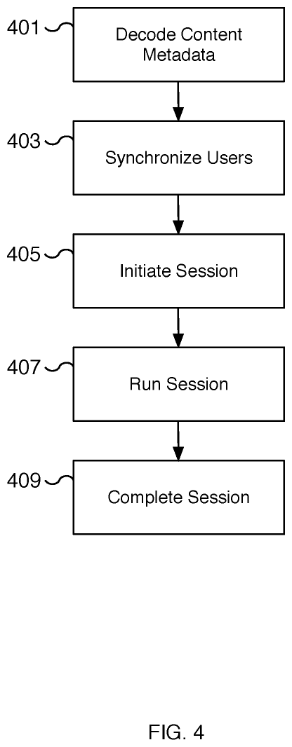

FIG. 4 is a flow chart illustrating an embodiment of a process for providing synchronized multiuser audio. In some embodiments, the process of FIG. 4 is used to play a synchronized multiuser audio recording to multiple users. In some embodiments, the process of FIG. 4 is performed at 105, 107, and/or 109 of FIG. 1. In some embodiments, the content played is generated using the process of FIG. 2 and the setup for playing the content is performed using the process of FIG. 3.

At 401, content metadata is decoded. In various embodiments, the content metadata includes data related to playing the content including the number of users, the hardware requirements for content effects, the length of the content, etc. The content metadata is decoded and may be used to synchronize users and initiate the session.

At 403, users are synchronized. In various embodiments, the users and their respective audio content are synchronized. For example, the audio recording for each user may be played from a stereo audio recording. In some embodiments, the audio content for each user is manually synchronized by the users. For example, a countdown or similar signal is used to synchronize each user's content. In the event optional hardware devices are used, the additional hardware devices are also synchronized with the audio content.

At 405, a session is initiated. For example, an audio-based session using a synchronized multiuser audio recording is initiated. In some embodiments, the initiation includes positioning each of the users in their correct physical location relative to one another. For example, the first user may be positioned to the left (or right) of the second user. The initiation may also include initializing the hardware devices and/or sensors such as the camera, camera flash, display, vibration module, etc. In some embodiments, the users are provided with directions such as closing the user's eyes as part of the initiation step. In some embodiments, the users are provided with instructions to capture certain audio or other media recordings that are used in the upcoming (or future) audio content. For example, an audio recording of a whisper, a scream, a laugh, certain phrases, etc. may be recorded and used when running the session. The recordings provide personalization for the audio content by using the user's own voice and sounds effects.

At 407, the session is run. In various embodiments, the session is run by playing the synchronized multiuser audio recording for each user. For example, the first user receives the first user's audio content via one ear speaker of a headphone pair and the second user receives the second user's audio content via a second ear speaker of the headphone pair. As the session runs, analytics may be captured such as when a user pauses or terminates the session and the user's heart rate, breathing, or other physical attributes. In various embodiments, different sensory actions may be performed as the session runs in sync with the audio content. Sensory actions include actions initiated by one of the users at the direction of the content and hardware effects such as using the flash, screen, and/or vibration of a smartphone device.

In some embodiments, the session includes the ability to capture media of the users while running the session. Audio content may include instructions for capturing audio, video, and/or photos of the session. The captured media can be used in the audio content, for example, by dynamically inserting the captured media into the audio content. In one scenario, an audio recording of a user's name is captured and then becomes part of the whispers of a haunted house. As another example, the captured media can be used to generate a highlight recording of the content. The highlight recording can be shared with other users to promote and/or highlight shareable moments of the session.

At 409, the session is completed. In various embodiments, the session completes when the users finish the audio content and/or when the audio content is paused or terminated. The session completion may be used to store analytics and/or other playback data. In some embodiments, users are presented with a user interface for providing feedback on the session. For example a survey is presented to ask the user the best, favorite, worst, scariest, funniest, and/or most thrilling part of the session, to rate the session, or other relevant feedback. In some embodiments, the feedback is based on a thumbs up/thumbs down or numeric score. The users can also provide content ratings and/or content categories for the content. In some embodiments, the feedback is used to help recommend future content to users.

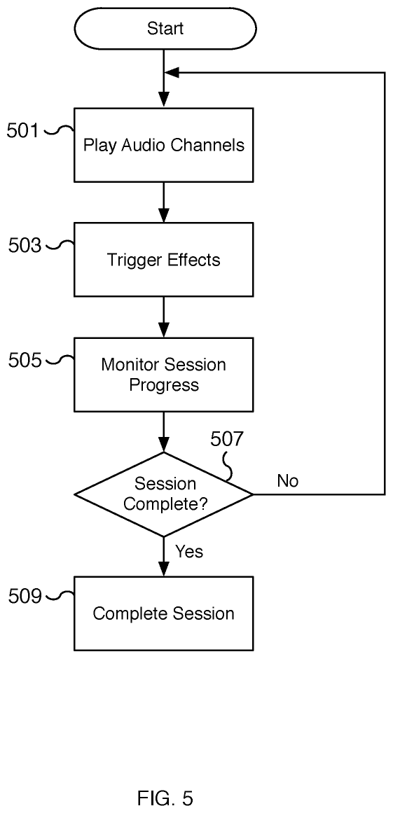

FIG. 5 is a flow chart illustrating an embodiment of a process for providing synchronized multiuser audio. In some embodiments, the process of FIG. 5 is used to play a session using a synchronized multiuser audio recording to multiple users. In some embodiments, the process of FIG. 5 is performed at 107 and 109 of FIG. 1 and/or at 407 and 409 of FIG. 4. In some embodiments, the content played is generated using the process of FIG. 2 and the setup for playing the content is performed using the process of FIG. 3.

At 501, the audio channels are played. For example, a first user's audio content is played to a left ear speaker and a second user's audio content is played to a right ear speaker. A first user receives the first user's audio content isolated from the second user's audio content. Similarly, the second user receives the second user's audio content isolated from the first user's audio content. In some embodiments, the first user's and second user's audio content share similar audio themes but contain different content. For example, the first user may be a passive listener to a narrative while the second user may receive audio instructions to perform sensory actions directed at the first user. In various embodiments, the two audio channels are synchronized such that the two users each receive a shared but different experience. In some embodiments, both users participate and perform different sensory actions directed at one another.

At 503, effects are triggered. For example, hardware and user performed sensor effects are triggered. For user-performed effects, a start signal and an optional stop signal may be included in the audio or text directions. For example, a start signal may be issued to direct a user to speak a particular sentence or to perform a particular physical action. As another example, a start signal may be used to direct the user to take a photo, record audio, or record video of the user, another user, or group of users as users experience a running session. In some embodiments, the hardware effects are performed using a hardware device. For example, the user places a smartphone in front of the other user's closed eyes and the camera flash performs a flame flickering effect to simulate fire. In various embodiments, the hardware effects may include one user positioning and/or setting up the hardware before the hardware effect is triggered. Hardware effects may include a variety of effects including flashing the camera flash, modulating a display screen including color and/or brightness, vibrating a device using a motorized actuator, haptic engine, or vibrating motor, etc. Effects can also be triggered by additional hardware devices such as additional smartphone devices, smart wearable devices, and/or smart home devices. The triggered effects may be synchronized using descriptor information that indicates the type of effect and the timing for performing the effect. In various embodiments, the descriptor information is used to control the start, stop, and intensity of the effect and to keep the effects in sync with the audio playing.

At 505, the session progress is monitored. In various embodiments, as the audio plays and effects are performed, the session progress is monitored. The monitoring includes determining whether the session is finished such as when the audio recording has finished playing and/or whether a user terminates or pauses the recording. In some embodiments, session monitoring includes tracking playback data such as analytics data. Playback data may include heart rate, breathing, or other physical state data of the users as well as when the users shout, scream, laugh, etc. Playback data may also include tracking the points at which different users drop out of the session. In some embodiments, the monitoring includes identifying when the hardware is no longer active such as when an ear speaker has been removed or a connection with a wireless headphone is no longer working.

At 507, a determination is made whether the session has completed. In the event the session is complete, processing continues to 509. In the event the session is not complete, processing continues back to 501 where the audio continues to be played.

At 509, the session is completed. Once a session is complete, completion steps are performed. In some embodiments, the completion steps are described with respect to step 409 of FIG. 4. In various embodiments, feedback is captured at the completion of a session and used for improving the user experience. In some embodiments, the completion step includes the ability to share memorable moments of the session. The completion step may also store playback data and feedback to a data store such as a remote database.

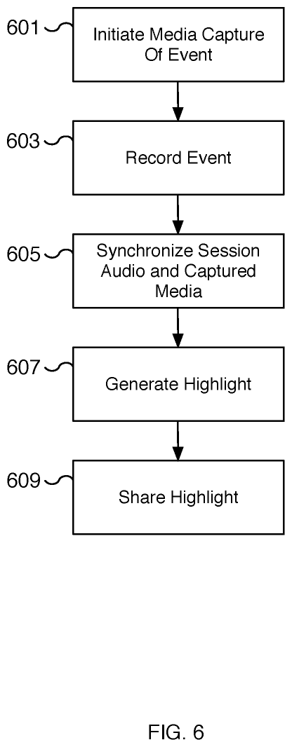

FIG. 6 is a flow chart illustrating an embodiment of a process for creating a highlight recording of a synchronized multiuser audio-based session. In some embodiments, the process of FIG. 6 is used to capture a highlight recording of a memorable moment during the running of a session using a synchronized multiuser audio recording for multiple users. In some embodiments, the process of FIG. 6 is performed at 107 and 109 of FIG. 1, at 407 and 409 of FIG. 4, and/or during the process of FIG. 5. In some embodiments, the content played as a basis for the highlight recording is generated using the process of FIG. 2 and the setup for playing the content is performed using the process of FIG. 3.

At 601, a media capture of an event is initiated. For example, the audio content of an audio recording directs one user to prepare a camera device such as a camera app of a smartphone device for recording media. The audio content heard by the user may include directions for how to position the camera device. In some embodiments, a camera application automatically opens in advance of the event to be captured based on timing information associated with the audio content.

At 603, the event is recorded. Using the camera recording functionality, an event is recorded. In some embodiments, the recording is a photo, audio, and/or video recording. In some embodiments, a user initiates the recording, for example, by following a start signal such as a countdown or similar trigger. The user may also stop the recording to complete the media capture by following a stop signal. In some embodiments, the recording is started and stopped automatically by specifying a camera effect with the appropriate capture time parameters. For example, a camera effect is described in descriptor information that starts and stops the event recording. A user may only be required to position the camera while the recording happens automatically.

In some scenarios, the recording is of a particularly memorable event of an audio-based session. For example, the event may be the climax event of a narrative. As another example, the event may be a scene where a user is expected to exhibit particular emotions such as laughter, shock, happiness, sadness, tenderness, peacefulness, etc. In various embodiments, the subject of the captured media may be the user, another user, a group of users, or another appropriate subject. For example, the camera event may be a selfie video of the users of a session as an event unfolds, the recording capturing a range of emotions of the participants.

At 605, the session audio and captured media are synchronized. Using the captured media recorded at 603, the audio content that played during the captured media is identified. In various embodiments, the audio content is pre-defined by the camera effect. In some embodiments, the video from the captured media is merged with audio content from the session that was played concurrently with the captured video. Timestamps of the captured media and audio content may be used for synchronizing the two different sources. In some scenarios, portions of the start and/or end of the captured media may be cropped to match the relevant portions of the session audio. In various embodiments, the session audio used may include one or more of the audio content heard by the different users. For example, the audio used may be the audio that the user in the recorded media heard. As another example, the audio may be a mix of different audio content sourced from audio content heard by users and/or the recorded captured media. The particular audio content may be defined by the camera effect. In some embodiments, the captured media is a photo or series of photos merged with the corresponding session audio. Since the audio content heard by users is not typically captured by the recorded captured media, the audio of the recorded captured media is mixed (or replaced) with the audio content heard by one or more users.

At 607, a highlight is generated. Using the synchronized portions of the captured media, including portions of the video, still images, and/or audio, with the synchronized portions of the relevant audio content, a highlight recording is generated. The highlight recording may include video, images, and/or audio of users experiencing the event mixed together with audio corresponding to the audio content that one or more users heard. The highlight recording may be generated on a local computing device such as the smartphone device used to capture the event. In some embodiments, the highlight recording is generated and stored on a remote server for hosting media files. In various embodiments, the highlight recording is a combined recording that combines a portion of the captured recorded video media with at least a section of the audio content of the audio recording corresponding to the time sequence of the recorded video media.

At 609, the highlight is shared. For example, the highlight recording generated at 607 is shared with the users of the session and/or other interested users. In some embodiments, the highlight recordings of many users who have run the same session are available for viewing. The different highlight recordings can be used to demonstrate how different users have experienced an event. In various embodiments, the highlight recordings can be shared online, for example, via a social media platform, email, a messaging platform, or through another appropriate delivery system. In some embodiments, the highlight recording is shared with the audio content removed to prevent revealing the audio content to new users.

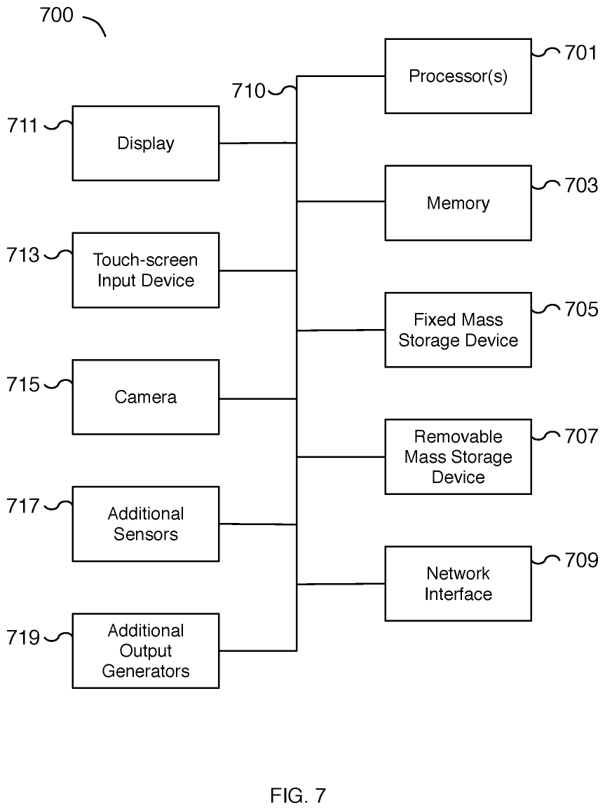

FIG. 7 is a functional diagram illustrating a programmed computer system for providing synchronized multiuser audio. For example, a programmed computer system may be a mobile device, such as a smartphone device, a tablet, a laptop, a smart television, and/or another similar device for providing synchronized audio to multiple users. As will be apparent, other computer system architectures and configurations can be used. Computer system 700, which includes various subsystems as described below, includes at least one microprocessor subsystem (also referred to as a processor or a central processing unit (CPU)) 701. For example, processor 701 can be implemented by a single-chip processor or by multiple processors. In some embodiments, processor 701 is a general purpose digital processor that controls the operation of computer system 700. Using instructions retrieved from memory 703, the processor 701 controls the reception and manipulation of input data, and the output and display of data on output devices (e.g., display 711). In some embodiments, processor 701 includes and/or is used to provide a synchronized audio-based session for multiple users via an output audio generator such as additional output generators 719. In some embodiments, processor 701 is used to perform at least part of the processes described with respect to FIGS. 1-6. In some embodiments, the programmed computer system is used to record captured media for generating a highlight recording using the process of FIG. 6.

Processor 701 is coupled bi-directionally with memory 703, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 701. Also as is well known in the art, primary storage typically includes basic operating instructions, program code, data, and objects used by the processor 701 to perform its functions (e.g., programmed instructions). For example, memory 703 can include any suitable computer-readable storage media, described below, depending on whether, for example, data access needs to be bi-directional or uni-directional. For example, processor 701 can also directly and very rapidly retrieve and store frequently needed data in a cache memory (not shown).

A removable mass storage device 707 provides additional data storage capacity for computer system 700, and is coupled either bi-directionally (read/write) or uni-directionally (read only) to processor 701. For example, removable mass storage device 707 can also include computer-readable media such as flash memory, portable mass storage devices, magnetic tape, PC-CARDS, holographic storage devices, and other storage devices. A fixed mass storage 705 can also, for example, provide additional data storage capacity. Common examples of mass storage 705 include flash memory, a hard disk drive, and an SSD drive. Mass storages 705, 707 generally store additional programming instructions, data, and the like that typically are not in active use by the processor 701. Mass storages 705, 707 may also be used to store user-generated content and digital media for use by computer system 700. It will be appreciated that the information retained within mass storages 705 and 707 can be incorporated, if needed, in standard fashion as part of memory 703 (e.g., RAM) as virtual memory.

In addition to providing processor 701 access to storage subsystems, bus 710 can also be used to provide access to other subsystems and devices. As shown, these can include a network interface 709, a display 711, a touch-screen input device 713, a camera 715, additional sensors 717, additional output generators 719, as well as an auxiliary input/output device interface, a sound card, speakers, additional pointing devices, and other subsystems as needed. For example, an additional pointing device can be a mouse, stylus, track ball, or tablet, and is useful for interacting with a graphical user interface. In the example shown, display 711 and touch-screen input device 713 may be utilized for displaying a graphical user interface for providing synchronized multiuser audio to users and/or for performing display effects synchronized with playing the multiuser audio. In some embodiments, camera 715 may be used for performing camera effects. Camera 715 may include a camera flash for performing camera flash effects. Additional output generators 719 may include a haptic sensor, actuator motor, or similar vibration module for performing vibration effects. Additional output generators 719 and/or network interface 709 may be used to implement a Bluetooth network connection to a wireless audio device for playing synchronized multiuser audio content.

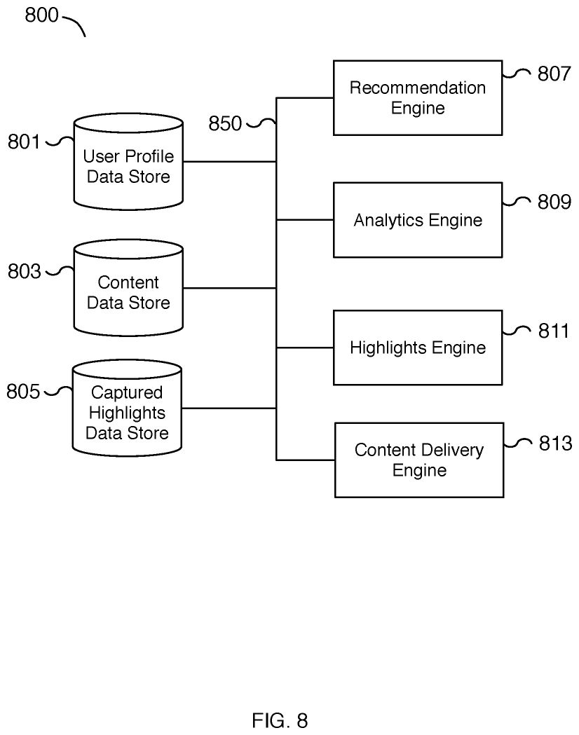

The network interface 709 allows processor 701 to be coupled to another computer, computer network, telecommunications network, or network device using one or more network connections as shown. For example, through the network interface 709, processor 701 can transmit/receive synchronized multiuser audio content and/or generated highlight recordings. A user can also submit session feedback over network interface 709 to a remote server. In some embodiments, network interface 709 allows processor 701 to communicate with a content platform such as content platform system 800 of FIG. 8. Further, through the network interface 709, the processor 701 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 701 can be used to connect computer system 700 to an external network and transfer data according to standard protocols. For example, various process embodiments disclosed herein can be executed on processor 701, or can be performed across a network such as the Internet, intranet networks, or local area networks, in conjunction with a remote processor that shares a portion of the processing. In some embodiments, network interface 709 utilizes wireless technology for connecting to networked devices such as content platform system 800 of FIG. 8 or smart devices such as smart home devices. In some embodiments, network interface 709 utilizes a wireless protocol designed for short distances with low-power requirements. In some embodiments, network interface 709 utilizes a version of the Bluetooth protocol. Additional mass storage devices (not shown) can also be connected to processor 701 through network interface 709.

An auxiliary I/O device interface (not shown) can be used in conjunction with computer system 700. The auxiliary I/O device interface can include general and customized interfaces that allow the processor 701 to send and, more typically, receive data from other devices such as wireless audio devices, microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above and magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 7 is but an example of a computer system suitable for use with the various embodiments disclosed herein. Other computer systems suitable for such use can include additional or fewer subsystems. In addition, bus 710 is illustrative of any interconnection scheme serving to link the subsystems. Other computer architectures having different configurations of subsystems can also be utilized.

FIG. 8 is a block diagram illustrating an embodiment of a content platform system for providing synchronized multiuser audio. The example content platform system 800 shown in FIG. 8 includes user profile data store 801, content data store 803, captured highlights data store 805, recommendation engine 807, analytics engine 809, highlights engine 811, and content delivery engine 813. Each of these components may be communicatively coupled via network 850. In some embodiments, content platform system 800 is used to host packaged content for playing synchronized multiuser audio-based sessions. In some embodiments, content platform system 800 is used to perform one or more of the processes of FIGS. 1-6. In some embodiments, content platform system 800 is a platform that runs on computer system 700 of FIG. 7.

In the example shown, user profile data store 801, content data store 803, and captured highlights data store 805 may be configured to store user profiles, session content, and/or captured highlights and related data corresponding to synchronized multiuser audio-based sessions. In some embodiments, user profile data store 801, content data store 803, and captured highlights data store 805 are each databases or another appropriate data store module. The data stores may be a single data store or replicated across multiple data stores.

In some embodiments, user profile data store 801 stores profile data including user configuration data of users of a content platform system for playing synchronized multiuser audio-based sessions. The user configuration data may include system preferences such as volume, language, speaker voice, playback device system settings, and other preference settings. The user profile data may include feedback data on content sessions as well as playback data including analytics data. The user profile data may also include session preferences such as preferred categories and content ratings. In some embodiments, the user profile data includes user account and demographic data. In various embodiments, recommendation engine 807, analytics engine 809, highlights engine 811, and/or content delivery engine 813 accesses user profile data store 801 to retrieve and/or update user profile data.

In some embodiments, content data store 803 stores content package data including content audio recordings and content effects as well as feedback on the stored content packages. Feedback stored in content data store 803 may include ratings and/or comments on the stored content packages. In some embodiments, content data store 803 is used to store content metadata including a title, a content category, a target user demographic, a content rating, a price, and/or content attributions, among other related content data. For example, content categories may include content targeting children and parents, content targeting intimate partner scenarios, and content with suspense or thriller aspects. Additional or fewer categories may be appropriate. In some embodiments, a rating system is used to categorize the content packages such as whether the content is appropriate for different ages and/or maturity levels. The content metadata may include keywords relevant to the content package. In some embodiments, content attributions are stored in content data store 803. Content attributions may be used to identify writers, producers, voice talent, sound effects producers, etc. associated with a packaged content. In various embodiments, recommendation engine 807, analytics engine 809, highlights engine 811, and/or content delivery engine 813 accesses content data store 803 to retrieve and/or update content packages and related data.

In some embodiments, captured highlights data store 805 stores captured highlight recordings and related highlight recording data. For example, captured highlights data store 805 stores feedback such as ratings and comments on shared highlight recordings. In various embodiments, the data store is optimized for storing and serving shared video to users. Captured highlights data store 805 may be further configured to store viewing and/or modification permissions for different highlight recordings. For example, the permissions for controlling the viewing of a particular highlight recording may be stored in highlights data store 805.

In some embodiments, recommendations engine 807 is used to recommend content for users. The recommendations may be based on user profile data stored in user profile data store 801 including feedback provided by each user and user profile data such as demographic data. Content ranked highly may be used to identify similar content that the user would likely enjoy. In some embodiments, content metadata stored in content data store 803 including the voice talent, writers, and content categories, among other metadata of available content, are used to match recommendations with users. As another factor, captured highlights stored in captured highlights data store 805 that are ranked favorably by a user may be used to increase the likelihood the corresponding content is recommended to that user. User preferences may also be used for determining recommended content. In various embodiments, the recommended content is provided as future content for the user. Recommendation engine 807 may access user profile data store 801, content data store 803, and/or captured highlights data store 805 to determine and/or store content recommendations.

In some embodiments, analytics engine 809 is used to store, process, and analyze analytics data associated with content and users. For example, content may be analyzed for when, during the playback, users stop participating in an audio-based session. The analysis results may be used to identify what type of content is received favorably and what type of content should be avoided. Content playback including the number of plays, the number of repeat plays, the likelihood a sequential session is played after the previous session is played, and other playback data are stored and analyzed. The analytics data may be used to increase user enjoyment and to identify or improve content for future playback sessions. In some embodiments, the analytics engine may be used to identify users for targeted promotions such as matching users with services, products, and/or content that would be well received by the user. Analytics engine 809 may access user profile data store 801, content data store 803, and/or captured highlights data store 805 to determine and/or store analytics data.

In some embodiments, highlights engine 811 is used to generate and/or host highlight recordings of content sessions. The generated highlight recordings may be generated using the process of FIG. 6 by a content platform server or by a local smartphone device used to play the synchronized audio recording. Once generated, the highlight recordings can be hosted by highlights engine 811. In some embodiments, highlight recordings from the same session are provided by highlights engine 811 in a central location to engage new users to play the particular content session. In various embodiments, hosted highlight recordings may be viewable by the user, users of the content session, or a larger audience. The viewing permissions can be configured using highlights engine 811. In some embodiments, feedback on highlight recordings, including ratings and comments, can be shared using highlights engine 811. Highlights engine 811 may access captured highlights data store 805 for storing and/or retrieving highlight recordings and/or feedback on highlight recordings.

In some embodiments, content delivery engine 813 delivers packaged content to users for playing a synchronized multiuser audio recording. The packaged content may include a synchronized audio recording and optional descriptor information for performing content effects. In some embodiments, content delivery engine 813 delivers content and captured highlight recordings to a smartphone device via a network connection. Content delivery engine 813 may provide caching, security, and/or performance improvements for hosting content packages. Content delivery engine 813 is configured to retrieve content packages from content data store 803 and captured highlight recordings from captured highlights data store 805.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving an audio recording that includes a first audio content for a first user in a left audio channel of the audio recording and a second audio content for a second user in a right audio channel of the audio recording, wherein the first audio content is synchronized with the second audio content within the audio recording; and
providing at least a portion of the audio recording for playback on a headphone, wherein a left ear speaker of the headphone provides the first audio content isolated for the first user and a right ear speaker of the headphone provides the second audio content isolated for the second user.

2. The method of claim 1, wherein the headphone is a wireless in-ear headphone with a first portion that includes the left ear speaker and a second portion that includes the right ear speaker, and the first portion and the second portion are not physically connected together.

3. The method of claim 1, wherein the headphone is connected to a smartphone device.

4. The method of claim 3, wherein an audio content of the audio recording is synchronized with a camera flash effect of the smartphone device.

5. The method of claim 4, wherein the camera flash effect of the smartphone device provides a strobe effect at a specified time within the audio recording.

6. The method of claim 3, wherein an audio content of the audio recording is synchronized with a display effect of the smartphone device.

7. The method of claim 6, wherein the display effect of the smartphone device modifies a brightness and a color of a display of the smartphone device at a specified time within the audio recording.

8. The method of claim 3, wherein an audio content of the audio recording is synchronized with a vibration effect of the smartphone device.

9. The method of claim 8, wherein the vibration effect of the smartphone device enables an actuator of the smartphone device or a wearable device with a specified intensity for a specified duration at a specified time within the audio recording.

10. The method of claim 1, wherein the first audio content includes an audio instruction to perform a sensory action directed to the second user.

11. The method of claim 1, further comprising providing an interface for adjusting a volume of the left audio channel corresponding to the first audio content independently from the right audio channel corresponding to the second audio content.

12. The method of claim 1, further comprising:
receiving a configuration setting of the first or second user; and
swapping a third audio content for the first or second audio content using the configuration setting.

13. The method of claim 12, wherein the configuration setting includes a language setting.

14. The method of claim 1, further comprising receiving a configuration setting remapping the first audio content with the left audio channel and the second audio content with the right audio channel, wherein a default configuration associates the first audio content with the right audio channel and the second audio content with the left audio channel.

15. The method of claim 1, further comprising:
providing an audio instruction to record a video, wherein the audio instruction includes a start signal and an end signal;
receiving a recorded video associated with the start signal and the end signal;
synchronizing the recorded video with a section of the audio recording corresponding to a time sequence of the recorded video; and
automatically generating a combined recording by combining at least a portion of the recorded video with at least a section of the audio recording corresponding to the time sequence of the recorded video.

16. The method of claim 1, wherein the audio recording is synchronized to control a wearable device or a smart home device, and the smart home device includes a smart light, a smart thermometer, or a smart speaker.

17. The method of claim 1, further comprising tracking a heart rate of the first user using a heart rate sensor of a wearable device and dynamically modifying the playback of at least a portion of the audio recording based on the tracked heart rate.

18. The method of claim 1, further comprising:
receiving a network request for the audio recording from a user device;
providing the audio recording; and
receiving analytic data associated with the provided audio recording and a user of the user device.

19. A system, comprising:
a processor; and
a memory coupled with the processor, wherein the memory is configured to provide the processor with instructions which when executed cause the processor to:
receive an audio recording that includes a first audio content for a first user in a left audio channel of the audio recording and a second audio content for a second user in a right audio channel of the audio recording, wherein the first audio content is synchronized with the second audio content within the audio recording; and
provide at least a portion of the audio recording for playback on a headphone, wherein a left ear speaker of the headphone provides the first audio content isolated for the first user and a right ear speaker of the headphone provides the second audio content isolated for the second user.

20. A computer program product, the computer program product being embodied in a non-transitory computer readable storage medium and comprising computer instructions for:
receiving an audio recording that includes a first audio content for a first user in a left audio channel of the audio recording and a second audio content for a second user in a right audio channel of the audio recording, wherein the first audio content is synchronized with the second audio content within the audio recording; and
providing at least a portion of the audio recording for playback on a headphone, wherein a left ear speaker of the headphone provides the first audio content isolated for the first user and a right ear speaker of the headphone provides the second audio content isolated for the second user.
